(19) United States
(12) Patent Application Publication
(10) Pub. No.: US 2012/0058800 A1
(43) Pub. Date: Mar. 8, 2012

(54) STRUCTURE OF MOVING RECORDING DEVICE FOR TRANSPORTATION TOOLS

(75) Inventor: Wen-Ching SHIH, Hsinchu County (TW)

(73) Assignee: LIAN WEN INTERNATIONAL TECHNOLOGY CO. LTD, Hsinchu City (TW)

(21) Appl. No.: 12/876,409

(22) Filed: Sep. 7, 2010

(51) Int. Cl. H04W 88/02

(52) U.S. Cl. 455/556.1

(57) ABSTRACT

An improved structure of a moving record device for transportation tools is provided in the present invention. It has a moving record device which is composed of a systematic framework having a wireless transceiver module, a moving record device, a computing equipment and a wireless communication module. The device can not only record all the status when a transportation tool is moving, but also remotely control or monitor the location and status of the transportation tool via internet by a computer or mobile phone.

### FIELD OF THE INVENTION

The present invention relates to an improved structure of a moving record device for transportation tools. More specifically, it relates to an improved structure using internet to link the moving record device for transportation tools with a computing equipment and a wireless communication module of a mobile phone. The moving record device can completely record the status when a car is moving and save it in a computer or a mobile phone. When the computer or mobile phone is turned on, status of the moving car can be remotely controlled.

### BACKGROUND OF THE INVENTION

When a car is moving, it may often encounter traffic accidents. It causes dispute for both sides if there is no evidence to clarify the fact of the accidents. Hence, some inventors have developed car recorders which can record what happens when a car is moving.

However, the conventional car recorders do not connect with a computer or a mobile phone. The status of the car can not be shown on the computer or mobile phone in time; it is only when after the accident that the car recorder can be submitted to relevant government agencies for comparison or reference of the traffic accident.

### SUMMARY OF THE INVENTION

The main goal of the present invention is to fulfill the mentioned purposes in view of the defects that the car recorder can not connect with a computer or a mobile phone. The means used in the present invention is to provide an improved structure of a moving record device for transportation tools. It comprises a wireless transceiver module, a moving record device, a computing equipment and a wireless communication module. With the wireless transceiver module, images of the moving record device are connected to the computing equipment of wireless communication module, such as a mobile phone. The status of the transportation tool can be monitored by the computer at home or the mobile phone anytime. In order to have a better understanding of the present invention for the examiner, the present invention is illustrated with drawings below.

### BRIEF DESCRIPTION OF THE DRAWING

FIG. 1 is a systematic framework diagram combining internet and a moving record device in the present invention.

FIG. 2 is a systematic framework diagram of an embodiment in the present invention.

FIG. 3 is a systematic framework diagram of a moving record device in the present invention.

FIG. 4 is a sketch for showing an embodiment of application of the moving record device on a motorcycle.

FIG. 5 is a sketch for showing an embodiment of application of the moving record device on a car.

### DETAILED DESCRIPTION OF THE PREFERRED EMBODIMENTS

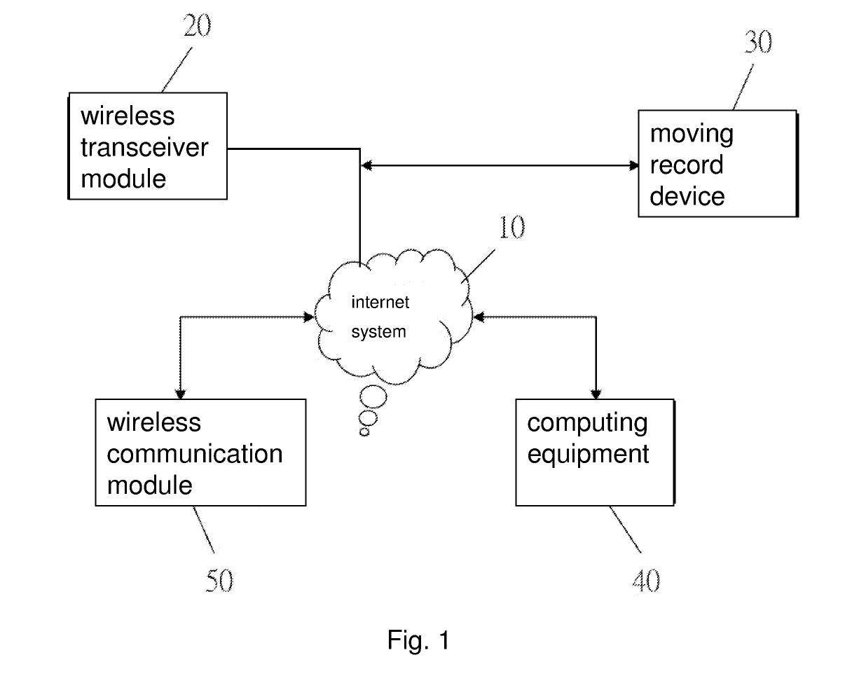

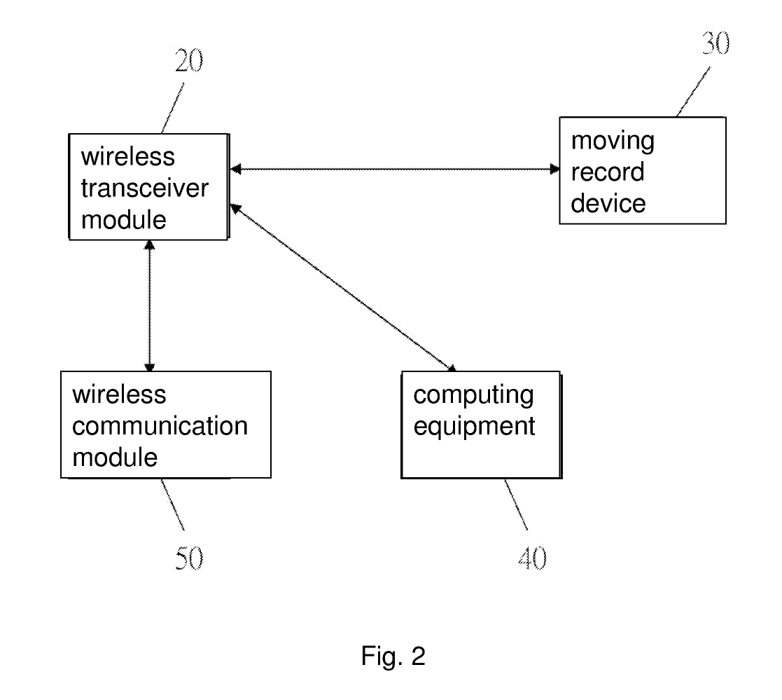

Please refer to FIG. 1 and FIG. 2. A systematic framework diagram shows a combination of internet and a moving record device to link to a computing equipment or a wireless communication module. An internet system 10 is set up in the transportation tool. The internet system 10 uses a wireless transceiver module 20 to link images of a moving record device 30 to a computing equipment 40 or a wireless communication module 50. The moving record device 30 can save the images, for example, one record for 3 hours, of the transportation tool to the computing equipment 40 or transfer them to the wireless communication module 50. People can turn on their computers at home to check the location and status of the transportation tool, such as a taxi, moving outside. It also works to turn on the wireless communication module 50 (or a mobile phone) anytime to check the status of the transportation tool.

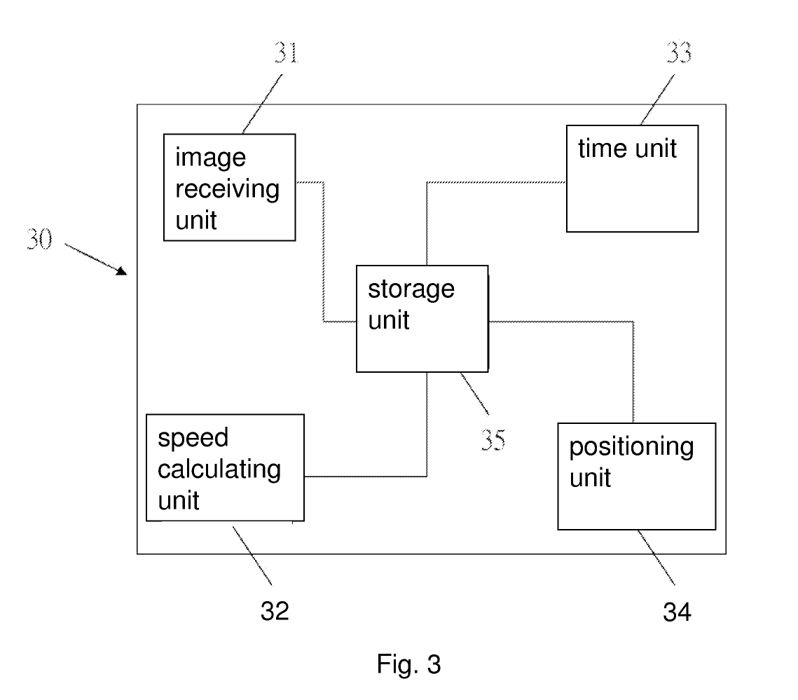

As shown in FIG. 3, it is a systematic framework diagram of the moving record device of the present invention. The moving record device 30 is composed of an image receiving unit 31, a speed calculating unit 32, a time unit 33, a positioning unit 34 and a storage unit 35. The image receiving unit 31, the speed calculating unit 32, the time unit 33 and the positioning unit 34 are connected to a storage unit 35. The moving record device 30 is installed in the transportation when it is manufactured. It is installed on a proper location and sealed so that it is not easy to open.

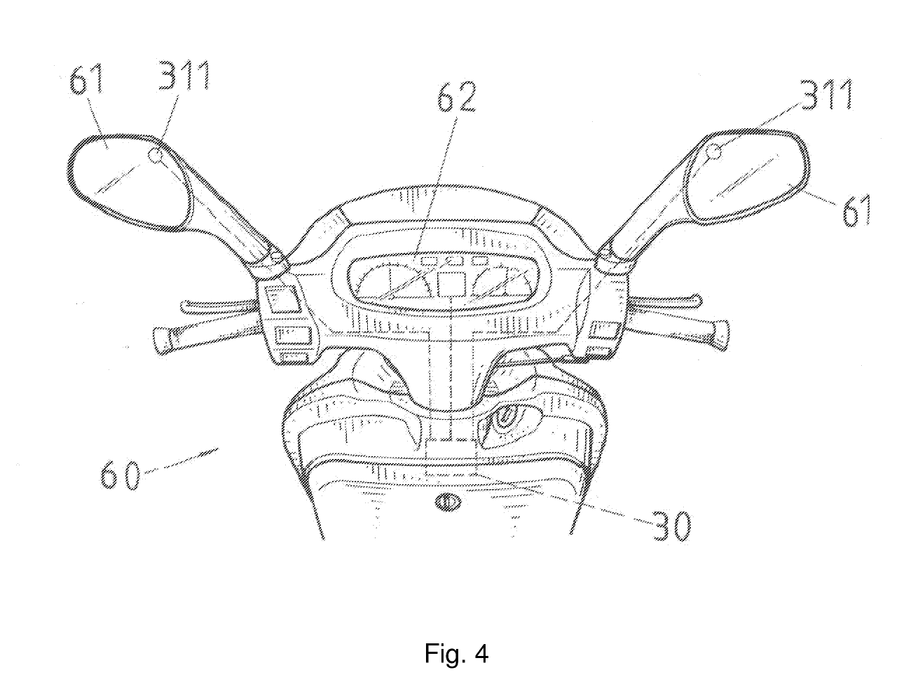

Please refer to FIG. 4. Take a motorcycle 60 for example. The moving record device 30 can be installed on the most proper location. It can also be installed in the most appropriate location according to the demand. A lens 311 is fabricated on a rear view mirror 61 of the motorcycle 60. The lens 311 can also be installed on a proper location, such as the front light of the motorcycle 60 or rear light, of the body of the motorcycle 60 according to users. It can take images from all sides. The lens 311 is connected to the image receiving unit 31 of the moving record device 30. The speed calculating unit 32 of the moving record device 30 is linked to a speedometer 62 of the motorcycle 60.

When the motorcycle 60 starts, the moving record device 30 will be initiated accordingly. The image receiving unit 31 will record the external images of the motorcycle 60 via the lens 311. The images will be saved in the storage unit 35 of the moving record device 30. The speed calculating unit 32 will calculate the value of the speedometer 32 of the motorcycle 60 and save it in the storage unit 35.

A time module is installed in the time unit 33. No matter the moving record device 30 is initiated or not, the time unit 33 will keep calculating. After the moving record device 30 is initiated, the time calculated by the time unit 33 will be saved in the storage unit 35. The positioning unit 34 itself has a module which uses the principle of global positioning system. It can save the positioned location data of coordinates in the storage unit 35.

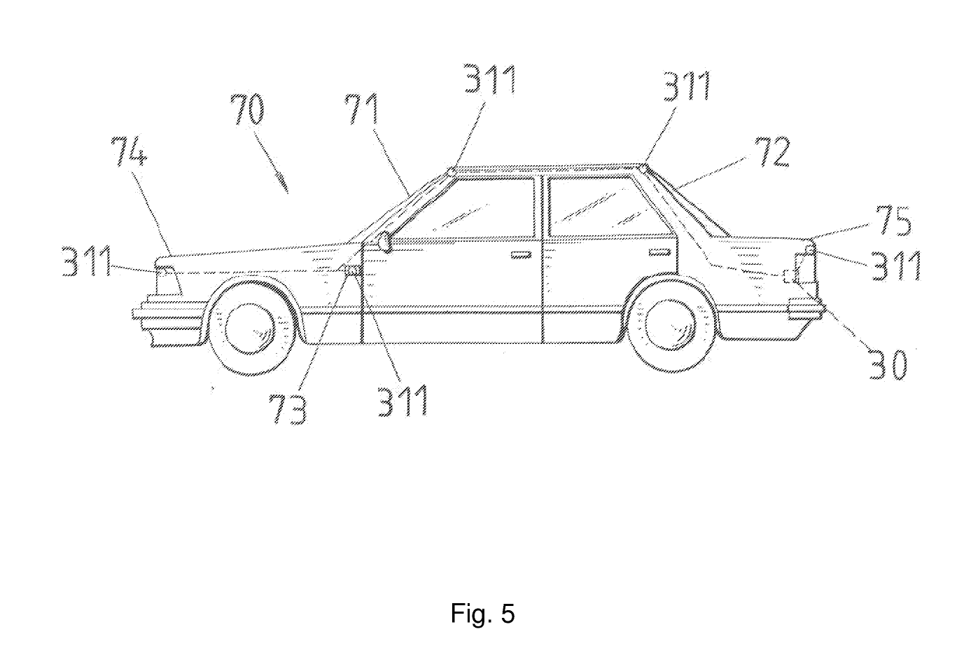

Please refer to FIG. 5. Take a car 70 for example. The moving record device 30 can be installed on the most proper location as well. It can also be installed according to the demand. Lenses 311 are installed in the proper location at the front windshield 71, a rear windshield 72, a directional light 73, a tank cover 74 and a rear of the car 75 of the car 70. It is linked to the image receiving unit 31 of the moving record device 30. The speed calculating unit 32 of the moving record device 30 is linked to a speedometer of the car 70. The embodiment is similar to the one of the motorcycle.

When a user encounters a traffic accident, he can hand over the moving record device 30 to a fair relevant government agency to tear down. The truth of the traffic accident can be found by the device. It can offer the evidence to clarify liability so that the rights of each side can be held. It can also help clean the site as soon as possible in case of traffic jam and waste of sources of justice.

Furthermore, if the user intends to leave and turn off the transportation tool, the transportation tool can have another button inside. When the ON button is pressed, the image receiving unit 31 of the moving record device 30 can continuously record the internal or external images of the car to monitor current images of the transportation tool at any time.

In summary, the improved structure of the moving record device for transportation tool of the present invention uses internet to link the moving record device to a computing equipment or a wireless communication module, such as a mobile phone. Hence, the moving record device can not only record and save the status of a transportation tool when it is moving, but check the current location and status of the transportation tool by a computer or a mobile phone. The status of the transportation tool outside can be remotely monitored at any time.

What is claimed is:

1. An improved structure of a moving record device for transportation tools, comprises:
a wireless transceiver module for transferring and receiving messages of a communication end;
a moving record device for connecting the wireless transceiver module by receiving and outputting internet data;
a computing equipment, receiving and outputting image signals, for transferring moving record device messages to the wireless transceiver module; and
a wireless communication module connecting to the moving record device or a computing equipment via the wireless transceiver module.

2. The improved structure of a moving record device for transportation tools according to claim 1, wherein the moving record device comprises:
a storage unit having proper memory space;
an image receiving unit, operating with a lens of the transportation tool, for saving the recorded images in the storage unit;
a speed calculating unit having a time calculating module, for saving the time value data in the storage unit; and
a positioning unit for positioning the location of the transportation tool by a global positioning system and saving coordinate data in the storage unit.

3. The improved structure of a moving record device for transportation tools according to claim 1, wherein the wireless communication module is a mobile phone.
